(19) United States
(12) Patent Application Publication
(10) Pub. No.: US 2015/0096628 A1
(43) Pub. Date: Apr. 9, 2015

(54) THREE POINT ATTACHMENT WITH HYDRAULIC QUICK ATTACH

(71) Applicant: Derek W. Kent, Becker, MN (US)

(72) Inventor: Derek W. Kent, Becker, MN (US)

(21) Appl. No.: 14/505,929

(22) Filed: Oct. 3, 2014

Related U.S. Application Data
(60) Provisional application No. 61/887,067, filed on Oct. 4, 2013.

(51) Int. Cl. A01B 63/10; E02F 9/22

(52) U.S. Cl. CPC A01B 63/10; E02F 9/2264; E02F 9/2278
USPC 137/334; 137/899

(57) ABSTRACT

A device for attachment to a three-point hitch of a tractor allowing for the use of high flow hydraulic attachments. The device includes a three-point hitch attachment, a hydraulic tank, a hydraulic pump powered by the tractor power take off, a filter, an oil cooler, and a quick attach. In use, the device is attached to the tractor allowing for the usage of skid steer attachments with the tractor controls.

### CROSS REFERENCE TO RELATED APPLICATIONS

This application claims priority to U.S. Provisional Patent Application No. 61/887,067 filed Oct. 4, 2013 to the above named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to an attachment for a three-point style hitch located on a tractor to support additional attachments.

### BACKGROUND OF THE INVENTION

A typical tractor includes a three-point hitch (or as it is sometimes called a three-point linkage) allowing for the attachment of various ploughs and implements. A three-point hitch is typically composed of a pair of lower arms and a top link together encompassing the three movable arms of the hitch and arranged in a triangular or A-shape. Typically, the two lower arms are the lifting arms and are controlled by the internal hydraulic system of the tractor. The top link forms the upper point of the three-point hitch and is typically movable, although it is not connected to the internal hydraulic system. All three of the hitch elements include an aperture or several apertures to receive attachable implements, typically with a retained pin.

In a typical configuration, the two lower arms are aligned with a power take-off (“PTO”) of the tractor, with the PTO centrally located between the pair of lower arms. This PTO is typically a splined shaft in communication with the tractor engine that allows for the attachment and powering of a dedicated PTO shaft and various implements. In combination, the three-point hitch and PTO work together to control and manipulate these various implements and attachments. This combination of the three-point hitch and PTO can adjust the speed, pitch, angle, height, and yaw of the various attachments and implements by utilizing the hydraulics and engine of the tractor.

Although the three-point hitch and PTO are extremely versatile at allowing for the attachment of implements, their capabilities are limited by the capacity and power of the tractor's internal hydraulic motor. This limitation prevents the attachment of skid loader style attachments utilizing a universal quick attach and requiring high-pressure hydraulics not provided by the tractor. Therefore, there is a need for a device for attachment to a three-point hitch that integrates a dedicated high flow/high pressure pump and a universal quick attach. Preferably, this device is powered by the PTO, compact, and easy to install.

### SUMMARY OF THE INVENTION

A three-point hitch with hydraulic pump and universal quick attach device for a tractor containing a three-point hitch is disclosed. The device is designed for attachment to the tractor three-point hitch to provide additional hydraulic capacity and flow for a universal quick attach to engage skid steer accessories and includes a three-point linkage, a hydraulic tank, a hydraulic pump, a hydraulic filter, an oil cooler, and a universal quick attach.

The device includes a frame to enclose the various components of the device and allow for attachment to the three-point hitch of the tractor. The frame has a first end proximal to the tractor three-point hitch and second end distal to the three-point hitch and opposite the first end. The first end of the frame is shaped to incorporate and includes a three-point hitch linkage for attachment to the three-point hitch of the tractor. The three-point linkage is composed of a pair of bottom members and a top link. The bottom members and top link are preferably apertures sized to receive pins mounted to the three-point hitch components and are aligned with a power take off (PTO) shaft of the tractor. In the preferred embodiment, the bottom members and top link are solidly constructed out of steel and integrated substantially with the frame for durability and strength.

Enclosed within the frame is the hydraulic tank and the hydraulic pump. The hydraulic tank is mounted to the frame and designed to contain hydraulic fluid. The hydraulic pump is mounted in communication with the hydraulic tank. The pump is powered by a shaft in communication with the PTO shaft of the tractor. The hydraulic tank and pump are designed to have the capacity and power capabilities to operate attachments primarily used for a skid steer or a skid loader.

Additional hydraulic components, including the hydraulic filter and the oil cooler, are mounted integral to the frame to provide for smooth hydraulic operation of the device. The filter and the cooler are mounted in line with the pump to both clean and cool the hydraulic fluid contained within the device hydraulic system. Within the hydraulic system various additional components such as valves, apertures, lines, hoses, connections, bearings, pumps, and other common materials used within the art now known or hereinafter learned may be used.

The frame second end includes the universal quick attach. The universal quick attach is designed to engage various additional attachments requiring hydraulics and typically used on a skid steer. The quick attach is primarily composed of pair locks located on the bottom side of the frame and in communication with a handle, wherein the handle will engage the quick attach locks. Quick attach systems are well known within the prior art and provide a universal format for the attachment of various tools and implements engaged for manipulation by the tractor. Therefore, it is understood that throughout this application, any reference to the quick attach is to a universal device or system for the attachment of implements in the style of a standard quick attach for a skid steer or skid loader.

In use, a user will attach the device to the tractor using the existing three-point hitch present on the tractor. The user will align the three-point linkage with the three-point hitch by connecting the top link to the upper most three-point hitch point and connecting the bottom members to the lower arms of the three-point hitch. The PTO is then connected to the hydraulic pump using the shaft. An attachment is engaged with the quick attach and the suitable hydraulic connections made. The user is then able to control the attachment using the tractor and its three-point hitch controls.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a side view of the three-point hitch with integrated hydraulic pump and quick attach, according to the present invention;

FIG. 2 is a rear view of the three-point hitch with integrated hydraulic pump and quick attach, according to the present invention.

### DETAILED DESCRIPTION OF THE INVENTION

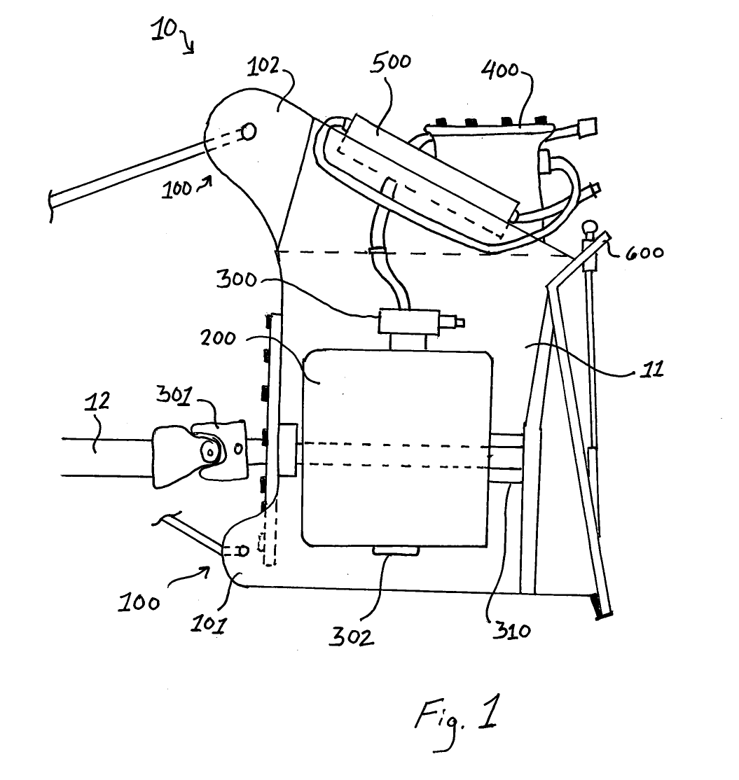

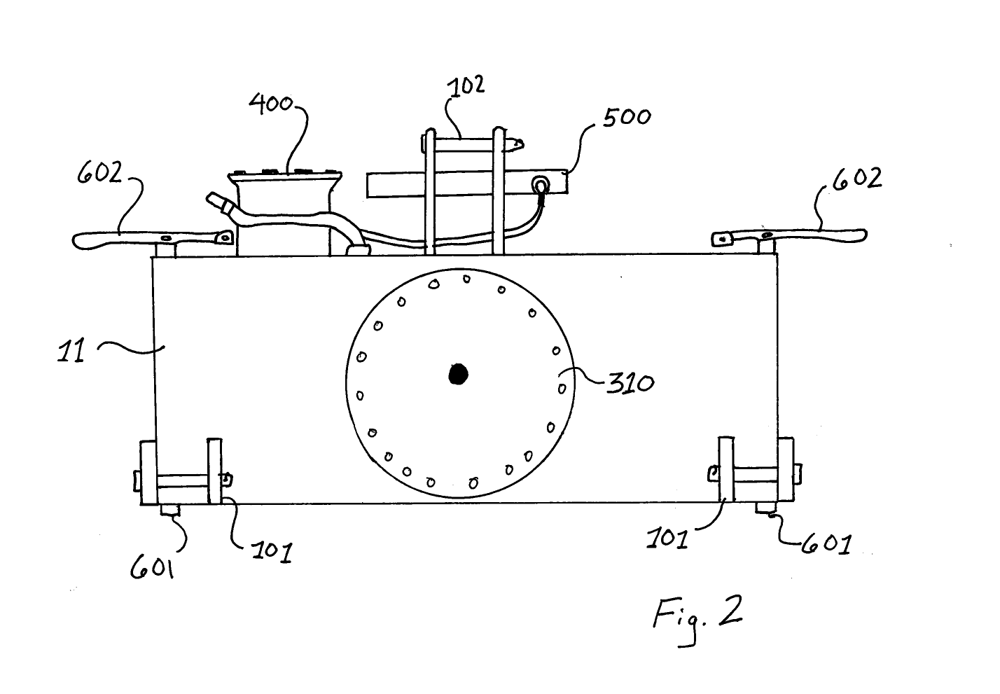

Referring now to FIG. 1-2 of a three-point hitch with hydraulic pump and universal quick attach device for attachment to a tractor containing a three-point style hitch according to the present invention is generally referred to as 10. The device 10 is designed for attachment to the tractor three-point hitch to provide additional hydraulic capacity and flow for universal quick attach skid steer accessories and includes a three-point linkage 100, a hydraulic tank 200, a hydraulic pump 300, a hydraulic filter 400, an oil cooler 500, and a quick attachment 600.

The device 10 has a frame 11 to enclose and support the various components of the device 10. The frame 11 has a first end proximal to the tractor three-point hitch and a second end distal to the three-point hitch and opposite the first end. The first end of the frame 11 is shaped to incorporate and include a three-point hitch linkage 100. The three-point linkage is composed of a pair of bottom members 101 and a top link 102. The bottom members 101 and top link 102 are preferably apertures sized to receive pins mounted to the three-point hitch components and aligned with a power take off (PTO) shaft 12 of the tractor. In the preferred embodiment, the bottom members 101 and top link 102 are solidly constructed out of steel and integrated substantially with the frame 11 for durability and strength.

Enclosed within the frame 11 is the hydraulic tank 200 and the hydraulic pump 300. The hydraulic tank 200 is mounted to the frame 11 and designed to contain hydraulic fluid. The hydraulic pump 300 is mounted in communication with the hydraulic tank 200. The pump 300 is powered by a shaft 301 in communication with the PTO shaft 12 of the tractor. The pump 300 may include a suction valve 302. The shaft 301 is supported by bearings 310 to allow for smooth rotation and engagement. The hydraulic tank 200 and pump 300 are designed to have the capacity and power capabilities to operate attachments primarily used for a skid steer or a skid loader.

Additional hydraulic components, including the hydraulic filter 400 and the oil cooler 500, are mounted integral to the frame 11 to provide for smooth hydraulic operation of the device 10. The filter 400 and the cooler 500 are mounted in line with the pump 300 to both clean and cool the hydraulic fluid contained within the device 10 hydraulic system. Within the hydraulic system various additional components such as valves, apertures, lines, hoses, connections, bearings, pumps, and other common materials used within the art now known or hereinafter learned may be used.

The frame 11 second end includes a quick attach 600. The quick attach 600 is designed to engage various additional attachments requiring hydraulics and typically used on a skid steer. The quick attach 600 is primarily composed of pair locks 601 located on a bottom side of the frame 11 and in communication with a handle 602, wherein the handle 602 will engage the quick attach locks 601. Quick attach systems are well known within the prior art and provide a universal format for the attachment of various tools and implements engaged for manipulation by the tractor. Therefore, it is understood that throughout this application, any reference to the quick attach is to a universal device or system for the attachment of implements in the style of a standard quick attach for a skid steer or skid loader.

In use, a user will attach the device 10 to the tractor using the existing three-point hitch present on the tractor. The user will align the three-point linkage 100 with the three-point hitch by connecting the top link 102 to the upper most three-point hitch point and connecting the bottom members 101 to the lower arms of the three-point hitch. The PTO is then connected to the hydraulic pump 300 using a shaft 301. An attachment is engaged with the quick attach 600 and the suitable hydraulic connections made. The user is then able to control the attachment using the tractor and its three-point hitch controls.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification.

What is claimed is:

1. A device for attachment to a three-point style hitch of a vehicle, the vehicle having a power take off, the device comprising:
a three point linkage, the linkage having attachment points corresponding the three-point style hitch for attachment;
a hydraulic tank, the hydraulic tank having a capacity for holding hydraulic fluid;
a hydraulic pump, the hydraulic pump in communication with the hydraulic tank, the hydraulic pump in communication with the power take off and capable of moving the hydraulic fluid; and
a quick attachment, the quick attachment capable of receiving an implement.

2. A device as claim 1, wherein the device includes a hydraulic filter, and an oil cooler.

3. A device as in claim 1, wherein the three point linkage is integrated within a frame.

4. A device for attachment to a three-point style hitch of a tractor, the tractor having a power take off, the device comprising:
a frame, the frame having a first end and a second end opposite the first end, the first end aligned proximal to the tractor and having an integrated three-point linkage for attachment to a top link of the three-point hitch and a pair of bottom members of the three-point hitch, the frame defining a periphery of the device and providing a surface for the mounting of components;
a hydraulic tank, the hydraulic tank having a capacity for the holding of hydraulic fluid;
a hydraulic pump, the hydraulic pump in communication with the hydraulic tank and in communication with the power take off and capable of moving hydraulic fluid; and
a quick attachment, the quick attachment located on the second end of the frame, the quick attachment capable of receiving a universal quick attach implement.

5. A device as in claim 4, wherein the device includes a hydraulic filter, and an oil cooler.

6. A device as in claim 4, wherein the hydraulic pump includes a shaft, the shaft connected to the power take off.

7. A device as in claim 4, wherein the hydraulic pump and the hydraulic tank are positioned within an interior of the frame.
